(19) United States
(12) Patent Application Publication
(10) Pub. No.: US 2007/0039889 A1
(43) Pub. Date: Feb. 22, 2007

(54) Compact membrane unit and methods

(76) Inventor: Edmundo R. Ashford, Spring, TX (US)

Correspondence Address: KENNETH L. NASH, P.O. BOX 680106, HOUSTON, TX, 77268-0106, US

(21) Appl. No.: 11/507,287

(22) Filed: Aug. 21, 2006

Related U.S. Application Data
(60) Provisional application No. 60/710,258, filed on Aug. 22, 2005.

(51) Int. Cl. B01D 61/00

(52) U.S. Cl. 210/650; 210/321.88; 210/321.89

(57) ABSTRACT

Modular or cartridge-type membrane units utilize hollow, cylindrical tubular housings or receivers to house strings of removable membrane modules (elements) and normally comprise arrays of pipes that act as membrane module housings. A pseudo header for fluidly interconnecting the array of pipes reduces weight and cost. The pseudo header may comprise portions that are buried within skid components such as the toe bar. An internal low friction coating permits a larger number of membrane cartridges to be utilized in any cylindrical tubular membrane housing. A center feed pseudo header permits flow in two directions through the tubular membrane housing to double hydraulic capacity.

This application claims priority from U.S. Provisional Patent Application No. 60/710,258, filed Aug. 22, 2005.

### BACKGROUND OF THE INVENTION

1. Field of the Invention

The present invention relates generally to membrane treating systems and, more particularly, to systems and methods for maximizing treating capacity while reducing the physical dimensions of height, width, depth, and footprint, and/or overall weight of a membrane unit.

2. Description of the Background

Membrane treating systems are often utilized in remote locations and locations where significant space and weight limitations apply. Membrane treating systems are often skid-mounted for easier transportation. Membrane units have a feed line of fluid (e.g. gas and/or liquid) to be treated, a residue line, and a permeate line. In natural gas membrane treating systems, typically the residue line is the treated gas output and the permeate line is the vented wastes, which may be flared. In various liquid and/or gas membrane treating systems, an array of membrane tubes or housings provide the environment for the separation process. The possible placement of the feed line, residue line, and permeate lines with respect to each of the tubes or housings is limited by functional requirements. The component designs for these systems such as valves, welding, flanges, pipes, manufacturing costs and so forth are accompanied by associated size and weight considerations. Conventional membrane unit designs for modular or cartridge-type membranes may utilize one or more horizontal rows of pipes manifolded together for receiving an input stream or feed line to form a membrane bank, which operates in parallel for processing the input stream. In other words, each bank may operate as a single processing unit. Multiple bank membrane units utilize several such banks of horizontal rows wherein the banks are stacked vertically on top of each other. This organizational design of membrane banks used for many years is based upon the long accepted orientation requirements for the feed lines, residue lines, and permeate lines to create operational flow through the membrane units.

The inventor believes that the improvements as discussed herein are highly advantageous over prior art systems and that there can be great advantages for certain applications, where treating capacity is maximized while reducing both the physical dimensions such as footprint, length, width, and height, and overall weight of a membrane unit. Consequently, there remains a long felt need for improved methods for making more efficient membrane units. Those skilled in the art have long sought and will appreciate the present invention, which addresses these and other problems.

### SUMMARY OF THE INVENTION

It is an object of the present invention to provide an improved membrane unit.

It is yet another object of the present invention to provide a membrane unit that can provide a greater output in terms of the membrane unit physical size and weight.

These and other objects, features, and advantages of the present invention will become apparent from the drawings, the descriptions given herein, and the appended claims. However, it will be understood that the above-listed objectives and/or advantages of the invention are intended only as an aid in quickly understanding aspects of the invention, are not intended to limit the invention in any way, and therefore do not form a comprehensive or restrictive list of objectives, and/or features, and/or advantages.

The presented concepts and innovations correspond to modular or cartridge-type membrane technology, which utilize hollow, cylindrical receivers to house strings of removable membrane modules (elements). In accord with the present invention, it is possible to maintain or augment treating capacity while decreasing the size and weight requirements. This downsizing in the required hardware is achieved largely via a re-design of the membrane process and component configuration. The conservation of materials and economy of scale associated with fabrication for this new, innovative membrane unit design also yields improved economics.

Accordingly, the present invention provides a method for processing an input fluid utilizing a membrane unit wherein the membrane unit may comprise a plurality of tubular membrane housings for holding a plurality of membrane cartridges. The plurality of tubular membrane housings are fluidly interconnected to form at least one bank of tubular membrane housings operable for processing the input fluid from a feed line to produce outputs that may comprise a residue line and a permeate line. The method may comprise one or more steps that result in formation of one or more pseudo-headers such as, for instance, providing a tubular wall for each of the plurality of tubular membrane housings that defines therein an interior region sized for receiving at least one of the plurality of membrane cartridges. Other steps may comprise fluidly interconnecting at least two tubular membrane housings by utilizing at least one lateral interconnection tubular positioned between the tubular membrane housings and extending laterally from an opening in the tubular wall of each of the tubular membrane housings. The method may further comprise providing at least one additional tubular for fluidly interconnecting a tubular membrane housing first end for each of the plurality of tubular membrane housings and connecting the at least one additional tubular to one of the feed line or the residue line or the permeate line. Other steps may comprise connecting the at least one lateral interconnection tubular to one of the feed line or the residue line.

The method may further comprise positioning at least one second lateral interconnection tubular between the two tubular membrane housings such that the second lateral interconnection tubular extends laterally from a second opening in the respective tubular wall for each of the at least two tubular membrane housings and whereby the second lateral interconnection tubular fluidly interconnects the tubular membrane housings. Other steps may comprise connecting the second lateral interconnection tubular to one of the feed line or the residue line.

The method may further comprise positioning at least one third lateral interconnection tubular between the at least two tubular membrane housings such that the third lateral interconnection tubular extends laterally from a third opening in the tubular wall for each of the two tubular membrane housings. Other steps may comprise connecting the at least one third lateral interconnection tubular to at least one of the feed line or the residue line.

The method may further comprise physically securing a plurality of skid support beams together for supporting the plurality of tubular membrane housings utilizing at least a portion of the feed line or the residue line.

The method may further comprise utilizing an internal low friction coating for sealing engagement with the at least one of the plurality membrane cartridges that permits relatively low friction axial movement of the plurality membrane cartridges along the tubular wall.

In another embodiment, the present invention comprises a membrane unit for processing an input fluid utilizing a pseudo header and may comprise components such as, for instance, a tubular wall for each of the plurality of tubular membrane housings that defines therein an interior region sized for receiving at least one of the plurality of membrane cartridges. In one embodiment, the interior region may comprise a membrane holding interior region in which respective of the plurality membrane cartridges are to be positioned during the processing of the input fluid. In addition, the interior region may comprise a membrane free interior region in which the plurality of membrane cartridges are not to be positioned during the processing of the input fluid thereby providing an open interior portion.

One end of the tubular membrane housing may be designated as a tubular membrane housing first end. At least one lateral interconnection tubular may be positioned between at least two tubular membrane housings. The lateral interconnection tubular extends laterally from an opening in the tubular wall for each of the at least two tubular membrane housings. The lateral interconnection tubular is preferably positioned for fluidly interconnecting each of the membrane free interior regions in the tubular membrane housings. As well, at least one additional tubular is for fluidly interconnecting the tubular membrane housing first end for each of the plurality of tubular membrane housings.

In one embodiment, the membrane free interior region may be positioned adjacent the tubular membrane housing first end for each of the at least two tubular membrane housings.

In another embodiment, the membrane may further comprise a tubular membrane housing middle portion for each of the at least two tubular membrane housings wherein the membrane free interior region is positioned at the tubular membrane housing middle portion for each of the at least two tubular membrane housings.

In another embodiment, the membrane may further comprise a tubular membrane housing second end opposite from the tubular membrane housing first end. The interior region for the at least two tubular membrane housings may further comprise a second membrane free interior region in which the plurality of membrane cartridges are not to be positioned during the processing of the input fluid, and wherein the second membrane free interior region is positioned adjacent the tubular membrane housing second end for each of the at least two tubular membrane housings. At least one second lateral interconnection tubular may be positioned between the at least two tubular membrane housings. The second lateral interconnection tubular extends laterally from a second opening in the respective tubular wall for each of the respective tubular membrane housings. In one embodiment, the second lateral interconnection tubular may be positioned for fluidly interconnecting the second membrane free interior regions in the at least two tubular membrane housings.

In another embodiment, the membrane unit may further comprise a tubular membrane housing middle portion for each of the at least two tubular membrane housings. The interior region for the respective tubular membrane housings may further comprise a third membrane free interior region in which the plurality of membrane cartridges are not to be positioned during the processing of the input fluid. The third membrane free interior region may be positioned at the tubular membrane housing middle portion for each of the at least two tubular membrane housings. At least one third lateral interconnection tubular may be positioned between the at least two tubular membrane housings. The third lateral interconnection tubular extends laterally from a third opening in the tubular wall for each of the at least two tubular membrane housings. The third lateral interconnection tubular may be positioned for fluidly interconnecting the third membrane free interior regions in the at least two tubular membrane housings. The third lateral interconnection might connected to the feed line to form a center feed membrane bank with fluid flow in two directions through the tubular membrane housings.

The membrane unit might further comprise a skid with a plurality of skid support beams for supporting the plurality of tubular membrane housings. At least one tubular, which may comprise the feeder header, permeate header, or the like may be utilized for physically securing the plurality of skid support beams together.

In another embodiment, a header with a lowermost bend therein may be provided to support the membrane unit.

In yet another embodiment, the membrane unit tubular walls may further comprise an internal low friction coating for sealing engagement with respective of the plurality membrane cartridges that permits relatively low friction axial movement of the membrane cartridges along the tubular walls.

### BRIEF DESCRIPTION OF THE DRAWINGS

FIG. 1 is an elevational view, in section, showing a compact skid mounted membrane unit with a membrane bank comprising vertically oriented horizontal pipes with a feed “pseudo header” leading to incorporated skid tow bar feeder header and a residue “pseudo header” leading to incorporated skid tow bar residue header, and flow therethrough in accord with one possible embodiment of the present invention;

FIG. 2 is a possible plan view of the compact skid mounted membrane unit of FIG. 1 in accord with one possible embodiment of the present invention;

FIG. 3 is an elevational view, in section, showing a compact skid mounted membrane unit with buried center feed header operable to double the treated gas output as compared to prior art membrane units in accord with another possible embodiment of the present invention;

FIG. 4 is an elevational view which shows enlarged relevant portions of buried headers wherein the headers have a double purpose as tow bars for a skid in accord with another possible embodiment of the present invention;

FIG. 5 is a possible plan view of the compact skid mounted membrane unit of FIG. 4 in accord with another possible embodiment of the present invention;

FIG. 6 is an elevational view, in section, showing enlarged portions of a center feeder header and flow to one side of the skid with a permeate header and residue header in accord with another possible embodiment of the present invention:

FIG. 7 is an enlarged elevational and end view, in section, which show pseudo header pipe configurations for possible use with low friction or friction resistant internal pipe coating in accord with another possible embodiment of the present invention;

FIG. 8 is an enlarged elevational view for an external residue or feed nozzle in accord with another possible embodiment of the present invention;

FIG. 9 is an elevational view wherein a vertical membrane cartridge bank utilizes an external vertical residue or feed header with a residue or feed “pseudo header” buried within the skid support and vertical permeate header in accord with another possible embodiment of the present invention;

FIG. 10 is an elevational view showing a compact skid unit wherein the feeder header doubles as the skid tow bar and the residue header doubles as the opposite end skid tow bar with a vertical permeate header in accord with another possible embodiment of the present invention; and

FIG. 11 is an elevational view of a skid-less installation wherein primary headers and center beams may be utilized to support the membrane unit in accord with another possible embodiment of the present invention.

While the present invention will be described in connection with presently preferred embodiments, it will be understood that it is not intended to limit the invention to those embodiments. On the contrary, it is intended to cover all alternatives, modifications, and equivalents included within the spirit of the invention and as defined in the appended claims.

### DETAILED DESCRIPTION OF THE PREFERRED EMBODIMENTS

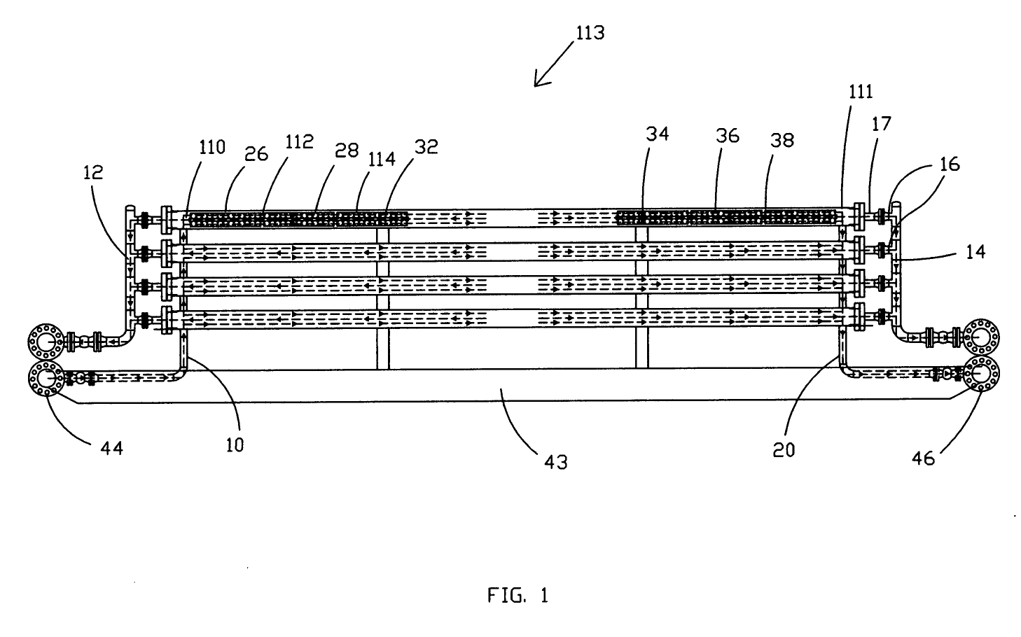

The present invention involves use of membrane units such as membrane unit 113 shown in FIG. 1. Prior art membrane units utilize headers for the feed line, residue line, and the permeate line. For instance, a typical prior art permeate header may be of the type of header as permeate header 12 shown in FIG. 1. However, in one embodiment of the present invention, the feed header and reside header are constructed in a considerably less expensive and less bulky manner. Thus, in one embodiment of the present invention, what may be referred to as a pseudo-header is provided. The use of feed pseudo-header 10 and residue pseudo-header 20, which in this example also incorporates buried portions 44 and 46 as discussed hereinafter, provides the benefits of a standard header as commonly used in the art, but at costs that are significantly reduced. At the same time, the pseudo-header results in a decrease in the size/weight of the membrane unit.

The multiple membrane housing arrays discussed previously are designed to operate in banks or multiple bank units that must be inter-connected via a header system, e.g., permeate header 12 or 14 shown in FIG. 1. Conventionally, what may be called sub-headers 16 are run in parallel with the bank, with nozzles 17 branching out to individual tubes. A pseudo-header in accord with the present invention is shown in most figures herein, e.g. pseudo-header 10 or 20 in FIG. 1. Thus, the pseudo-header interconnects adjacent horizontal or vertical tubes into a bank by feeding one side of a tube housing, permitting ‘flow’ through the interior space of the first housing, out an aperture on the opposing side (or adjacent side at some angle ⊖) and into the next housing via a small interconnecting pipe.

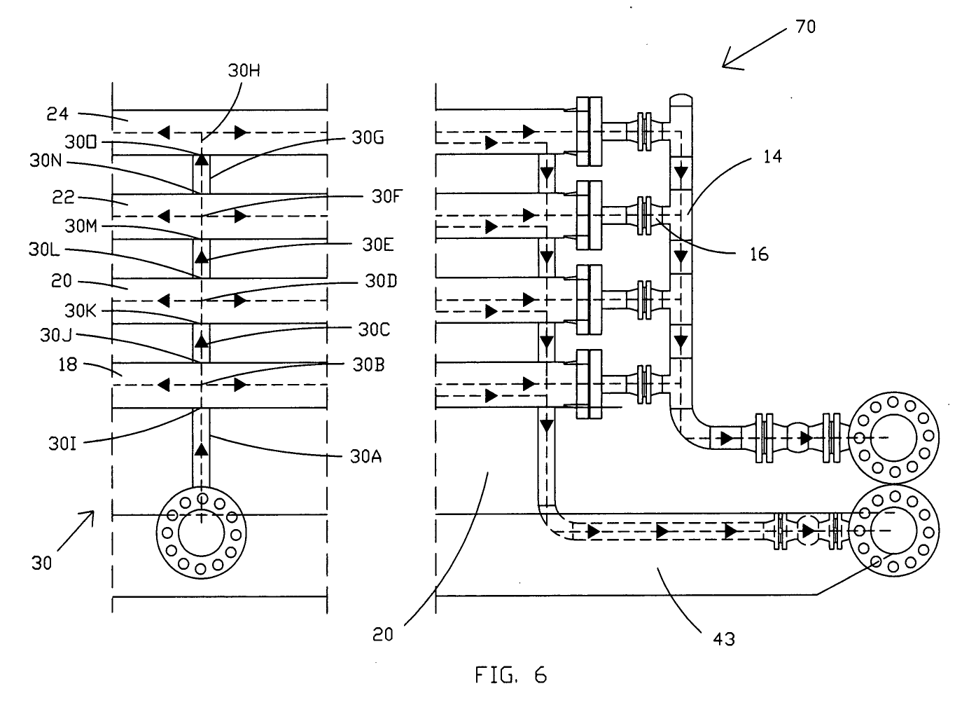

Referring to the enlarged views of FIG. 6, pseudo-header 30 interconnects adjacent vertical tubes or tubular membrane housings 18, 20, 22, and 24 into a bank by feeding one side of a tube housing, permitting ‘flow’ through the interior space of the first housing, out an aperture on the opposing side (or adjacent side at an angle ⊖°) and into the next housing via small interconnecting pipes which may be referred to as lateral interconnection tubular components 30A, 30C, 30E, and 30F. In this case, header lateral interconnection tubular component 30A connects to interior space 30B through hole 301 in the side of tubular 18. Interior space 30A may typically also be referred to as membrane free interior region 30A of tubular 18, because the membrane cartridges, (see e.g. membrane cartridges 26, 28, 32, 34, 36, 38 in FIG. 1,) may preferably not be positioned in this interior space 30B when an input fluid is being processed. Thus, header lateral interconnection tubular components 30A, 30C, 30E, and 30F interconnect interior spaces 30B, 30D, 30F and 30H via openings 30I, 30J, 30K, 30M, 30N, and 300 in the side of the respective tubular membrane housings 18, 20, 22, and 24. As discussed above, interior spaces 30B, 30D, 30F and 30H, may normally be regions that are free of the membrane cartridges during operation and therefore may also typically be referred to as membrane free interior regions 30B, 30D, 30F, and 30H. Flow through the feed pseudo header 30, residue pseudo header 20, and permeate header 14 is shown by the arrows.

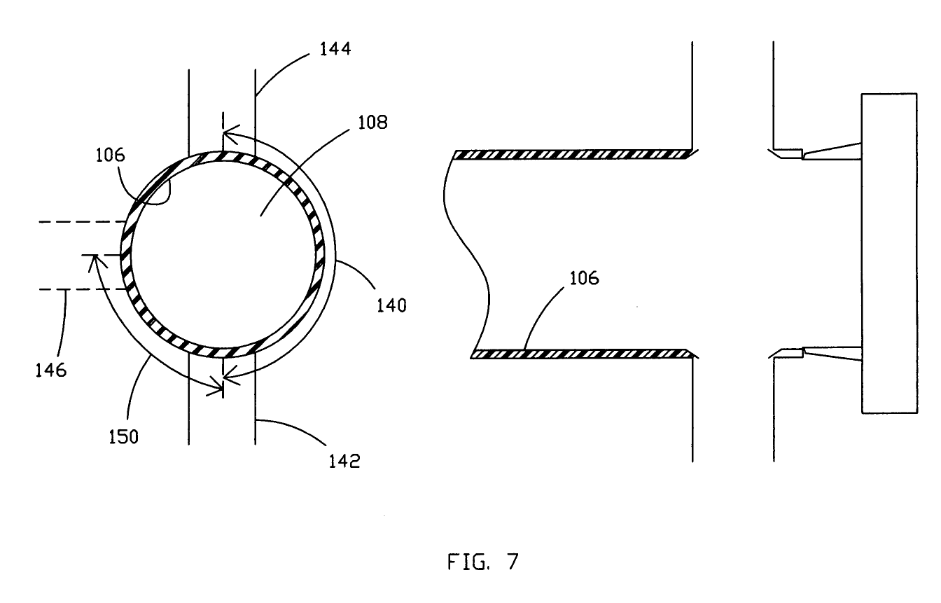

As shown in FIG. 7, the interconnection pipes, which may be referred to as lateral interconnection tubular components 144, 146, 148, may be laterally mounted such as by welding at the side of tubular membrane housing 108 at any desired angles 140 and 150. In FIG. 7, angle 150 is 90 degrees and angle 140 is 180 but other angles might also be utilized depending on the arrangement of the tubular membrane housings to be connected together.

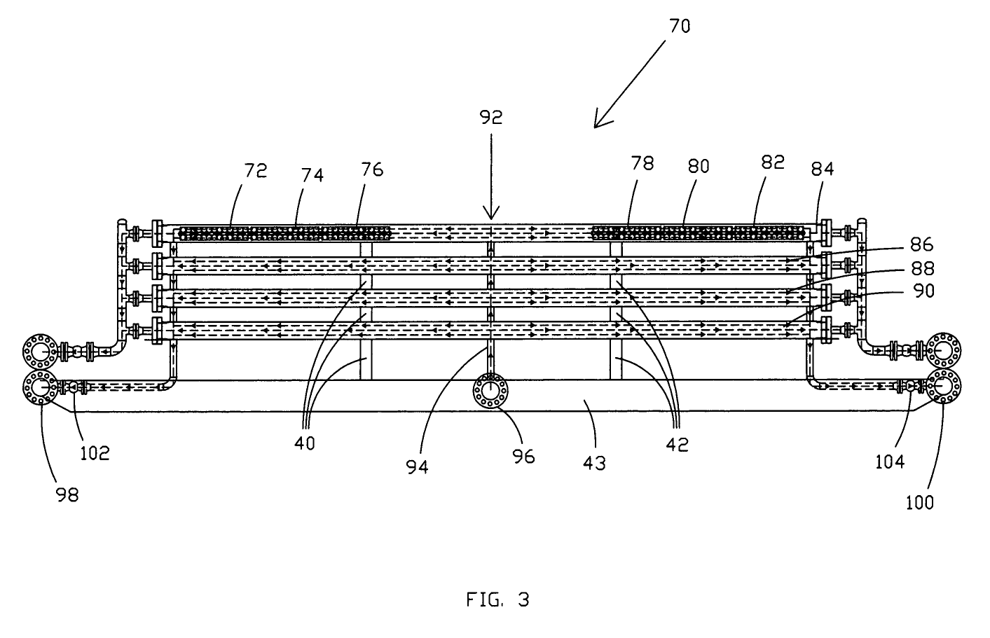

The term pipes and tubulars or tubulars or interconnecting tubulars or pipes are used interchangeably herein. An added advantage of the pseudo-header configuration is the ability of header lateral interconnection tubular components 30A, 30C, 30E, and 30F to provide structural support to vertical tube banks. These header supports may be used in place of conventional structural beams 40 and 42, as shown in FIG. 3. This greatly reduces the required space between adjacent tubes (housings) and eliminates the associated weight of a conventional bank header and supports. The cost of header lateral interconnection tubular components 30A, 30C, 30E, and 30F and related openings 30I, 30J, 30K, 30M, 30N, and 30O in the tubular membrane housings is much less than that of the costly traditional header assemblies, such as header assemblies 12 and 14 (See FIG. 1).

In another embodiment of the present invention, what may be referred to herein as “buried headers” may be utilized as shown in FIGS. 1, 4 and 9. Prior art skid designs require vertical, primary headers for Feed, Residue and Permeate transmission. Additionally, many skid mounted designs incorporate the use of horizontal tow bars for supporting the skid support beams 43. The presented design allows primary buried feed header 44, primary buried residue header 46, primary residue or feed header 48, or primary buried permeate header 50 to be “buried” within the structure of the skid, utilizing the tow bars as transmission headers where possible as shown in FIGS. 1, 4 and 9. Thus, these elements become tow bars or cross-members that physically support skid support beams 43. Associated valves, such as ball valves 45 and 47 may also be “buried” into the skid components.

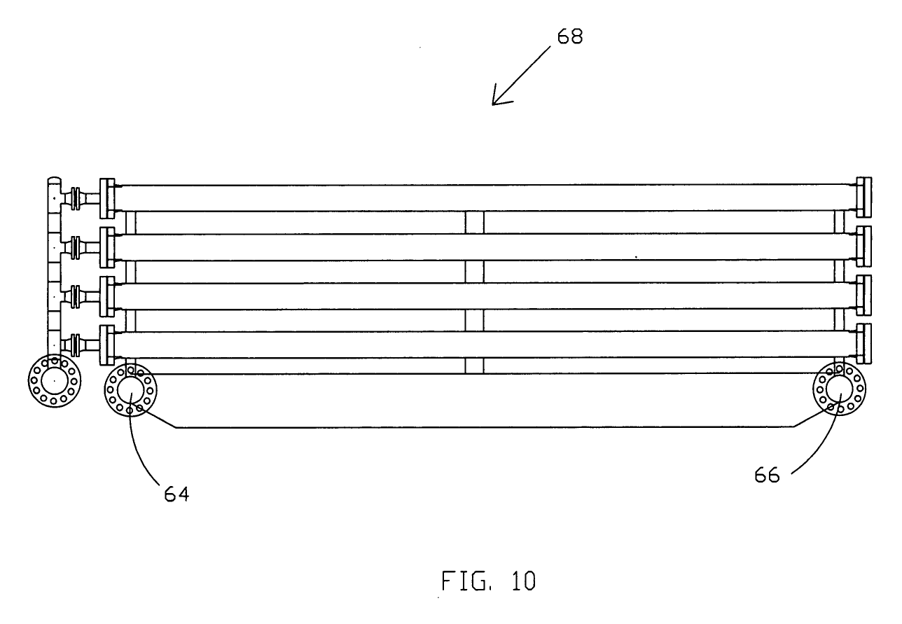

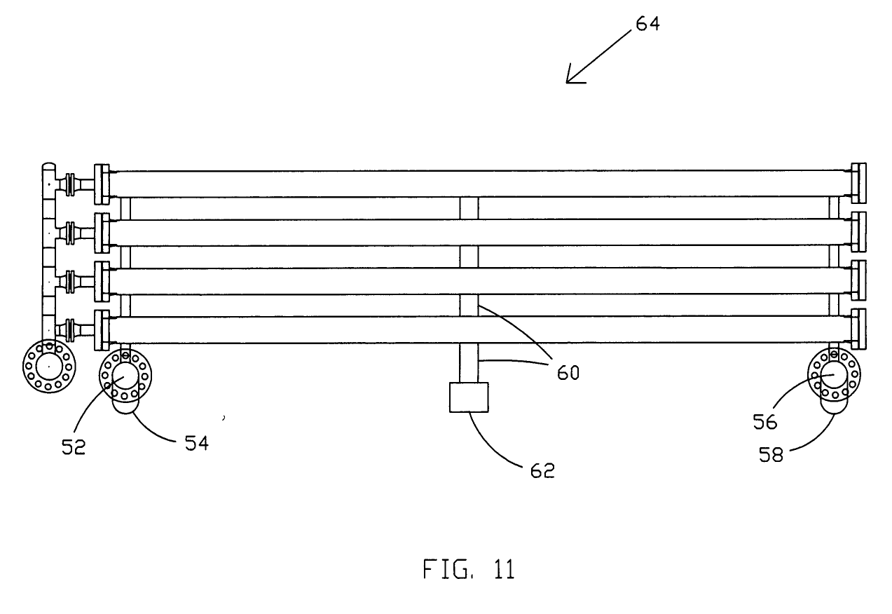

When a “skid-less” design is required, the primary headers can be slightly modified to double as footers for the unit as shown in FIG. 11, wherein center beam support 60 utilizes footer 62 for engaging the rig floor or the like where the skid-less membrane unit 64 is utilized. In this case, the respective pipe bottoms 52 and 58 are formed within primary feed header 52 and primary residue header 56 to thereby engage the deck of an offshore rig, or the like. If desired, a plate may be secured to respective pipe bottoms 52 and 58. “Buried headers”, including the employment of tow bars or “barfooters” as primary headers, helps reduce weight and promote compact designs. In lengthened skid designs, certain valves (if necessary) can be “buried” in a similar fashion, below T.O.S. (Top of Skid). In addition, tow bars can be aligned directly below “Pseudo-Header” where possible, such as pseudo feed header/tow bar 64 and pseudo-residue header/tow bar 66 to minimize piping and/or footprint of membrane unit 68 as shown in FIG. 10.

For some applications, a center feed configuration membrane unit 70 as shown more clearly in FIGS. 3 and 6 of the present invention may be utilized to double the hydraulic capacity of the membrane unit to process the input fluid. Prior art membrane tubes (housings) are supplied with Feed gas at one end and yield Residue gas at the other end. Therefore, a membrane tube has a hydraulic flow capacity, which limits the amount of fluid that can travel longitudinally through a given housing. This configuration of the membrane unit causes wasted space in cases where the number of membrane cartridges is sufficient for processing a desired flow but the flow capacity limitation requires additional housings wherein fewer membrane cartridges are required. For instance, three membrane cartridges 72, 74, and 76 may be all that is required for processing a desired flow. However, there is room in tubular membrane housing 84 for additional membrane cartridges 78, 80, and 82 that would otherwise be wasted in traditional units. In accord with the present invention, where the number of membrane cartridges is sufficient for processing a desired flow, then feed line gas is supplied to the center region 92 of each tube or tubular membrane housing 84, 86, 88, and 90 via (in this case buried) primary pseudo feed header 94, such that the flow splits in opposite directions and yields residue streams at each end of the same tube or tubular membrane housing.

The arrows show the fluid flow through center feed configuration membrane unit 70. A center feed configuration membrane unit 70 in accord with the present invention therefore allows each tubular membrane housing 84, 86, 88, and 90 to be fed twice its apparent hydraulic capacity when compared to conventional designs. The center feed design can be used in conjunction with both the “Pseudo-header” and “Buried header” concepts as shown in FIGS. 3 & 6. For instance, in center feed configuration membrane unit 70, center feed pseudo-header 94 may comprise a pipe and header flange 96 that is used as a cross member within skid support beams 44. Likewise, residue pseudo-headers 98 and 100 are provided as toe bars that are cross-members welded to skid support beams 43. Control valves 102 and 104 may also be provided as part of the skid as well. Toe bars may typically be used to toe or push or lift the skid into position and generally provide part of a protective frame.

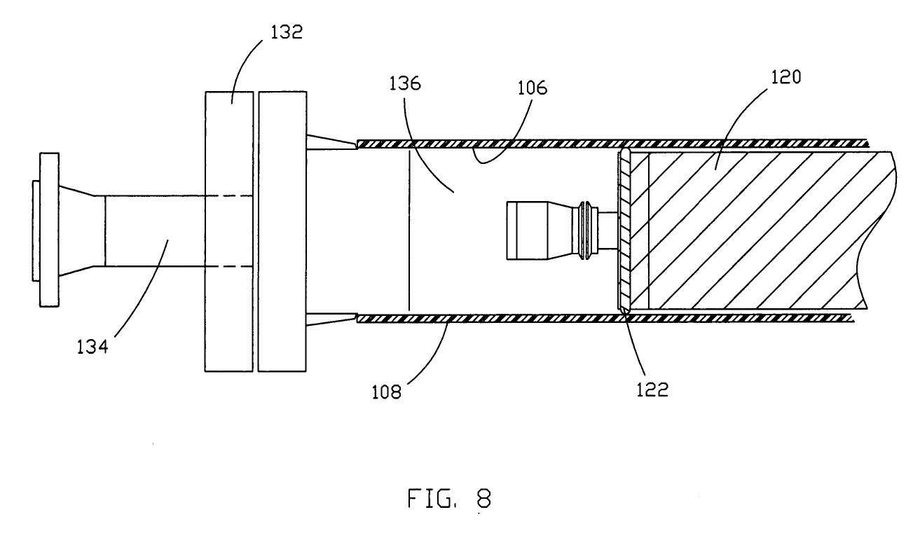

Referring to FIGS. 7 and 8, in another embodiment of the present invention, low friction coating 106 may be utilized within tubular membrane housing 108. Membrane cartridges such as membrane cartridge 120, which may be a wound cartridge or other type of membrane cartridge as known in the art, may typically comprise annular seal 122, as shown in FIG. 8. Tubular membrane housings (membrane tubes) designed for removable membrane cartridges (modules), such as membrane cartridges 26, 28, 32, 34, 36, and 38 in FIG. 1 that employ annular seals such as seals 110, 112, and 114, often experience heavy frictional forces during the insertion and extraction of these modules, (also called elements). The actual number of modules which a tube can hold is largely limited by the cumulative friction (or conversely ease of movement) caused by the targeted string of modules. Prior art systems may commonly handle only one to six modules. However, in accord with the present invention as discussed below, a tube may handle in excess of six modules. As a non-limiting example, tubular membrane housing 108 with low friction coating 106 in accord with the present invention may handle ten to twelve commonly used modules with relative ease wherein all modules may be safely inserted and/or removed.

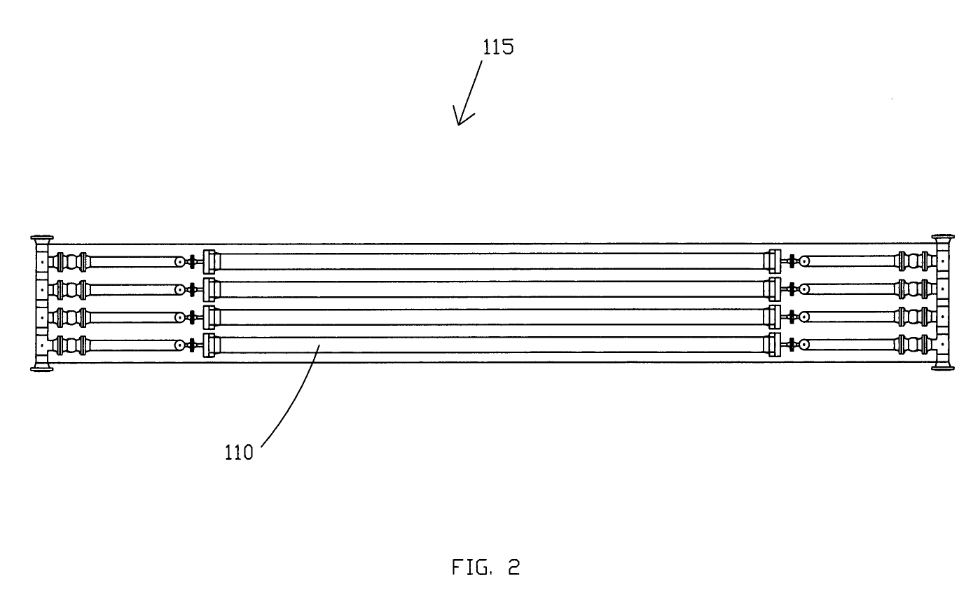

Accordingly, the present invention permits the manufacturing option of using longer tubular membrane housings (tubes) which handle more modules. Making the tubes or housings longer is a relatively minor additional manufacturing cost as compared to adding new housings along with the expensive fixtures required therefore. In accord with the present invention, the need for the number of tubular housings required can be reduced, thereby greatly reducing the overall size/cost of the membrane unit. Prior art attempts to overcome this problem involve the use of sliding sleeves. However, the sliding sleeves then increase the diameter of housing needed and therefore result in greater bulkiness of the system. In accord with another embodiment of the invention, low friction coating 106 that comprises TEFLON or TEFLON-like material can be applied or attached to the inner wall of the housing to facilitate movement of the module string (series of modules) and allow for longer strings as shown in 7. The TEFLON or TEFLON-like materials may be those that are presently known for reducing friction, and which can be firmly affixed to the inner surfaces of the housings in relatively thin layers and are suitable for the types of gases/fluids encountered. This allows for longer tubes 110 with increased membrane/treating capacity and an associated economy of scale during construction as shown membrane units 113 and 115 in FIGS. 1 and 2. While the process adds some time and cost for manufacture, the operating benefits far outweigh the disadvantage of these costs.

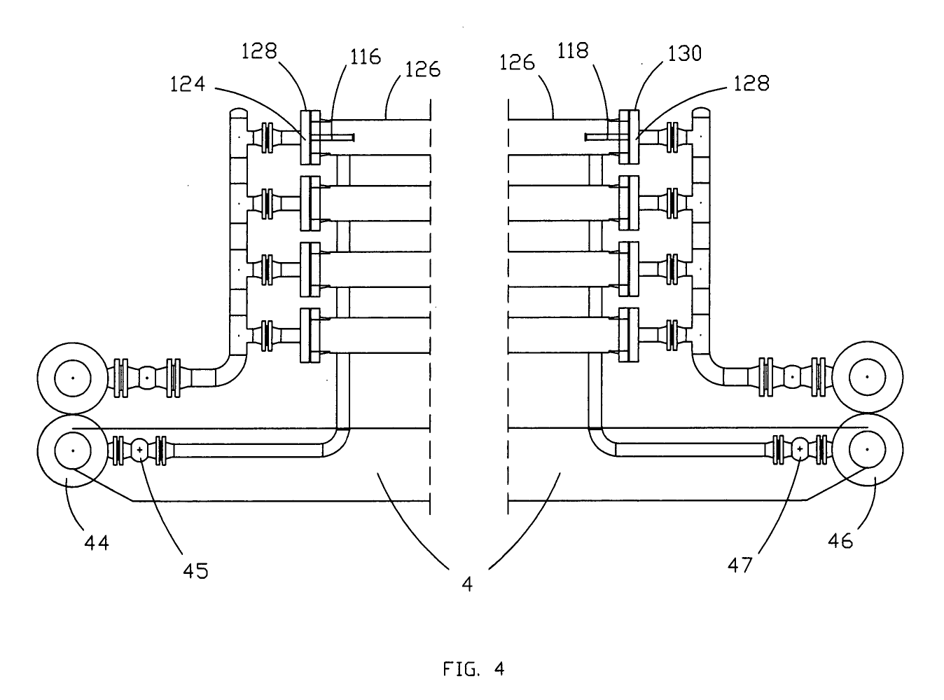

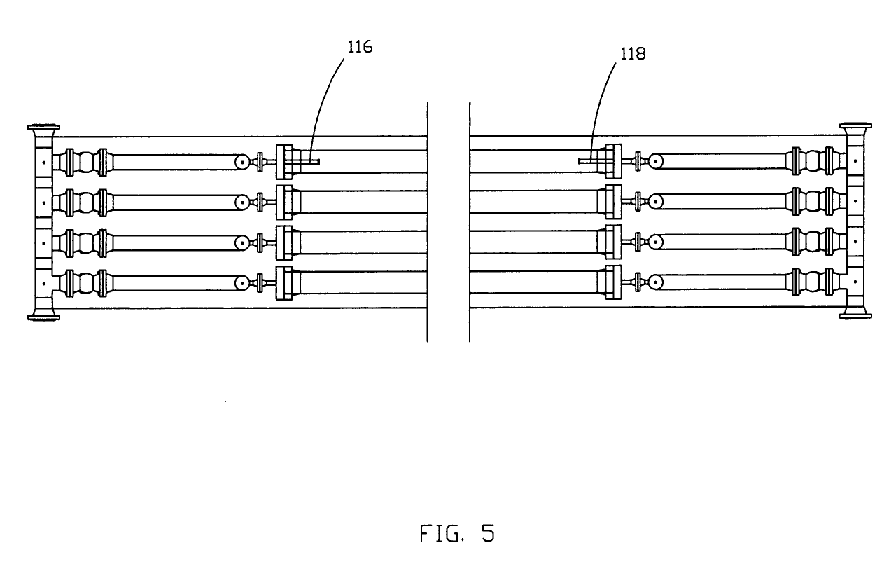

Conventional membrane housings have removable closures 124, 130 at one end or both ends of the tubes; such as tube 126, as shown FIGS. 4 and 5. Typically, one or both of these end caps/closures 124, 130 must be perforated and outfitted with a protruding interior tube-style duct 128 with an inserted receiver, such as receivers 116 and 118 (See FIGS. 4 & 5). Common membrane modules have central/core tubes used to transmit individual permeate or residue streams separated from the feed stream. Most typically, these core tubes of the modules are connected to the receiver of these protruding interior tubes from a perforated end cap (Ex. ANSI Flange).

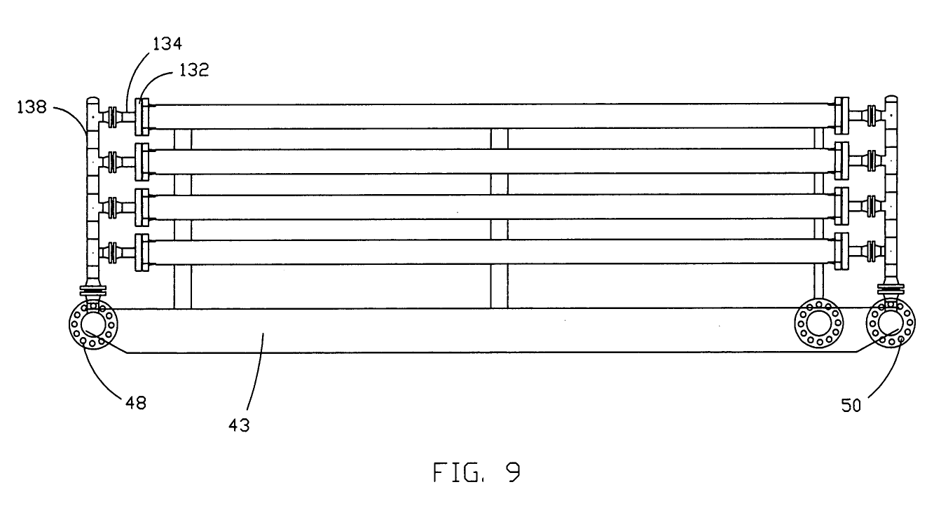

In accord with the present invention as shown in FIGS. 8 and 9, perforated end cap 132 can be used with flow nozzle 134 for the feed or residue streams to provide a vertical bank arrangement similar to that wherein the “pseudo header” is utilized as discussed above. An “End Cap Flow Nozzle 134,” as described herein, does not require a protruding interior tube stem as has been used in the prior art. Instead, gas is allowed to flow through the perforated end cap 132 directly to or from the interior “open space” 136 within the actual membrane housing 103. An exterior nozzle 134 is used in conjunction with each end cap to inter-connect flow to a common header 138 as shown in FIGS. 8 & 9.

By working around the known restrictions in placements of feed lines, residue lines, and permeate lines in accord with the present invention, treating capacity is maintained or augmented while decreasing the size and weight requirements of the overall membrane unit. The conservation of materials and economy of scale associated with fabrication for this new, innovative membrane unit design also yields improved economics. The tubular receivers in accord with the present invention can be arranged in different configurations including vertically oriented banks.

Accordingly, the foregoing disclosure and description of the invention is illustrative and explanatory thereof, and it will be appreciated by those skilled in the art, that various changes in the components and features, combinations of described features, ordering of steps, ranges, and/or attributes and parameters, as well as in the details of the illustrations or combinations of features of the methods and apparatus discussed herein, may be made without departing from the spirit of the invention.

What is claimed is:

1. A method for processing an input fluid utilizing a membrane unit, said membrane unit comprising a plurality of tubular membrane housings for holding a plurality of membrane cartridges used for processing said input fluid from a feed line to produce outputs comprising a residue line and a permeate line, said method comprising:
providing a tubular wall for each of said plurality of tubular membrane housings that defines therein an interior region sized for receiving at least one of said plurality of membrane cartridges;
fluidly interconnecting at least two tubular membrane housings to form a bank of tubular membrane housings by utilizing at least one lateral interconnection tubular positioned between at least two tubular membrane housings and extending laterally from an opening in said tubular wall for each of said at least two tubular membrane housings;
providing at least one additional tubular for fluidly interconnecting a tubular membrane housing first end for each of said plurality of tubular membrane housings;
connecting said at least one additional tubular to one of said feed line or said residue line or said permeate line; and
connecting said at least one lateral interconnection tubular to one of said feed line or said residue line.

2. The method of claim 1 further comprising:
positioning at least one second lateral interconnection tubular between said at least two tubular membrane housings such that said at least one second lateral interconnection tubular extends laterally from a second opening in said respective tubular wall for each of said at least two tubular membrane housings and whereby said at least one second lateral interconnection tubular fluidly interconnects said at least two tubular membrane housings; and
connecting said at least one second lateral interconnection tubular to one of said feed line or said residue line.

3. The method of claim 2 further comprising:
positioning at least one third lateral interconnection tubular between said at least two tubular membrane housings such that said at least one third lateral interconnection tubular extends laterally from a third opening in said tubular wall for each of said at least two tubular membrane housings and whereby said at least one third lateral interconnection tubular fluidly interconnects said at least two tubular membrane housings; and
connecting said at least one third lateral interconnection tubular to at least one of said feed line or said residue line.

4. The method of claim 1 further comprising physically securing a plurality of skid support beams together for supporting said plurality of tubular membrane housings utilizing at least a portion of said feed line or said residue line.

5. The method of claim 1, further comprising utilizing an internal low friction coating for sealing engagement with said at least one of said plurality membrane cartridges that permits relatively low friction axial movement of said plurality membrane cartridges.

6. A membrane unit for processing an input fluid, said membrane unit comprising a plurality of tubular membrane housings for holding a plurality of membrane cartridges, said plurality of tubular membrane housings being fluidly interconnected to form at least one bank of tubular membrane housings wherein said at least one bank of tubular membrane housings is operable for processing said input fluid from a feed line to produce outputs comprising a residue line and a permeate line, said membrane unit comprising:
a tubular wall for each of said plurality of tubular membrane housings that defines therein an interior region sized for receiving at least one of said plurality of membrane cartridges, said interior region comprising a membrane holding said interior region in which respective of said plurality membrane cartridges are to be positioned during said processing of said input fluid, said interior region comprising a membrane free interior region in which said plurality of membrane cartridges are not to be positioned during said processing of said input fluid;
a tubular membrane housing said first end for each of said plurality of tubular membrane housings;
at least one lateral interconnection tubular being positioned between at least two tubular membrane housings, said at least one lateral interconnection tubular extending laterally from an opening in said tubular wall for each of said at least two tubular membrane housings, said at least one lateral interconnection tubular being positioned for fluidly interconnecting each of said membrane free interior regions in said at least two tubular membrane housings; and
at least one additional tubular for fluidly interconnecting said tubular membrane housing first end for each of said plurality of tubular membrane housings.

7. The membrane unit of claim 6, wherein said membrane free interior region is positioned adjacent said tubular membrane housing first end for each of said at least two tubular membrane housings.

8. The membrane unit of claim 6 further comprising a tubular membrane housing middle portion for each of said at least two tubular membrane housings, and wherein said membrane free interior region is positioned at said tubular membrane housing middle portion for each of said at least two tubular membrane housings.

9. The membrane unit of claim 6 further comprising a tubular membrane housing second end opposite from said tubular membrane housing first end for each of said at least two tubular membrane housings, said interior region for said at least two tubular membrane housings further comprising a second membrane free interior region in which said plurality of membrane cartridges are not to be positioned during said processing of said input fluid, and wherein said second membrane free interior region is positioned adjacent said tubular membrane housing second end for each of said at least two tubular membrane housings, and further comprising at least one second lateral interconnection tubular being positioned between said at least two tubular membrane housings, said at least one second lateral interconnection tubular extending laterally from a second opening in said respective tubular wall for each of said at least two tubular membrane housings, said at least one second lateral interconnection tubular being positioned for fluidly interconnecting said second membrane free interior regions in said at least two tubular membrane housings.

10. The membrane unit of claim 9 further comprising a tubular membrane housing middle portion for each of said at least two tubular membrane housings, said interior region for said at least two tubular membrane housings further comprising a third membrane free interior region in which said plurality of membrane cartridges are not to be positioned during said processing of said input fluid, and wherein said third membrane free interior region is positioned at said tubular membrane housing middle portion for each of said at least two tubular membrane housings, and further comprising at least one third lateral interconnection tubular being positioned between said at least two tubular membrane housings, said at least one third lateral interconnection tubular extending laterally from a third opening in said tubular wall for each of said at least two tubular membrane housings, said at least one third lateral interconnection tubular being positioned for fluidly interconnecting said third membrane free interior regions in said at least two tubular membrane housings.

11. The membrane unit of claim 10 wherein said third lateral interconnection is connected to said feed line.

12. The membrane unit of claim 6 wherein said at least one additional tubular is connected to said feed line or said residue line or said permeate line, and said at least one lateral interconnection tubular is connected to said feed line or said residue line.

13. The membrane unit of claim 6 further comprising a skid with a plurality of skid support beams for supporting said plurality of tubular membrane housings, said at least one additional tubular being utilized for physically securing said plurality of skid support beams together.

14. The membrane unit of claim 6 further comprising a header with a lowermost bend therein on which said membrane unit is supported.

15. The membrane unit of claim 6, wherein said tubular wall further comprises an internal low friction coating for sealing engagement with respective of said plurality membrane cartridges that permits relatively low friction axial movement of said at least one of said plurality membrane cartridges along said tubular wall.

16. A method for processing an input fluid utilizing a membrane unit, said membrane unit comprising a plurality of tubular membrane housings for holding a plurality of membrane cartridges, said plurality of tubular membrane housings being fluidly interconnected to form at least one bank of tubular membrane housings wherein said at least one bank of tubular membrane housings is operable for processing said input fluid from a feed line to produce outputs comprising a residue line and a permeate line, said method comprising:
providing a tubular wall for each of said plurality of tubular membrane housings that defines therein an interior region sized for receiving at least one of said plurality of membrane cartridges;
providing that said interior region comprises a membrane holding interior region and a membrane free interior region;
prior to said processing of said input fluid, positioning said plurality of membrane cartridges within said membrane holding interior region of said plurality of tubular membrane housings while providing that said plurality of membrane cartridges are not positioned in said membrane free interior region of said plurality of tubular membrane housings;
fluidly interconnecting each of said membrane free interior regions in said at least two tubular membrane housings by utilizing at least one lateral interconnection tubular positioned between at least two tubular membrane housings and extending laterally from an opening in said tubular wall for each of said at least two tubular membrane housings;
providing at least one additional tubular for fluidly interconnecting a tubular membrane housing first end for each of said plurality of tubular membrane housings;
connecting said at least one additional tubular to one of said feed line or said residue line or said permeate line; and
connecting said at least one lateral interconnection tubular to one of said feed line or said residue line.

17. The method of claim 16, further comprising providing that said membrane free interior region is positioned adjacent said tubular membrane housing first end for each of said at least two tubular membrane housings.

18. The method of claim 16 further comprising providing a tubular membrane housing middle portion for each of said at least two tubular membrane housings wherein said membrane free interior region is positioned at said tubular membrane housing middle portion for each of said at least two tubular membrane housings.

19. The method of claim 16 comprising:
providing that said interior region for said at least two tubular membrane housings further comprises a second membrane free interior region in which said plurality of membrane cartridges are not to be positioned during said processing of said input fluid, and wherein said second membrane free interior region is positioned adjacent a tubular membrane housing second end for each of said at least two tubular membrane housings wherein said second end is opposite from said tubular membrane housing first end;
positioning at least one second lateral interconnection tubular between said at least two tubular membrane housings such that said at least one second lateral interconnection tubular extends laterally from a second opening in said respective tubular wall for each of said at least two tubular membrane housings and whereby said at least one second lateral interconnection tubular fluidly interconnects said second membrane free interior regions in said at least two tubular membrane housings; and
connecting said at least one second lateral interconnection tubular to one of said feed line or said residue line.

20. The method of claim 19 comprising:
providing that said interior region for said at least two tubular membrane housings further comprises a third membrane free interior region in which said plurality of membrane cartridges are not to be positioned during said processing of said input, and wherein said third membrane free interior region is positioned at a tubular membrane housing middle portion for each of said at least two tubular membrane housings;
positioning at least one third lateral interconnection tubular between said at least two tubular membrane housings such that said at least one third lateral interconnection tubular extends laterally from a third opening in said tubular wall for each of said at least two tubular membrane housings and whereby said at least one third lateral interconnection tubular fluidly interconnects said third membrane free interior regions in said at least two tubular membrane housings; and
connecting said at least one third lateral interconnection tubular to at least one of said feed line or said residue line.
